(19) United States
(12) Patent Application Publication
(10) Pub. No.: US 2015/0281777 A1
(43) Pub. Date: Oct. 1, 2015

(54) PROFILE MANAGEMENT FOR DIGITAL TELEVISION

(71) Applicant: IFEELSMART, Paris (FR)

(72) Inventors: Shy Shriqui, Paris (FR); Xavier Bringue, La Garenne Colombes (FR); Quentin Thiberville, Paris (FR)

(21) Appl. No.: 14/435,090

(22) PCT Filed: Oct. 8, 2013
(86) PCT No.: PCT/FR2013/052401

§ 371 Date: Apr. 10, 2015

(30) Foreign Application Priority Data
Oct. 11, 2012 (FR) 1259723

(51) Int. Cl. H04N 21/45; H04N 21/441; H04N 21/4788; H04N 21/466; H04N 21/475; H04N 21/4782; H04N 21/41; H04N 21/454

(52) U.S. Cl. CPC H04N 21/4532; H04N 21/4126; H04N 21/441; H04N 21/4542; H04N 21/4661; H04N 21/4751; H04N 21/4755; H04N 21/4782; H04N 21/4788

(57) ABSTRACT

A method for personalizing interaction with multimedia content and services presented on a television controlled by at least one peripheral device on the basis of a plurality of profiles, the profiles defining at least one interaction personalization, comprising: a step of forming a database containing a default profile corresponding to a user community, and optionally at least one individual profile corresponding to a user who is a member of the community; and steps of filtering access to the multimedia content and services and of personalizing the interaction with the multimedia content and services on the basis of the selected user profile, and, if connected with the default profile, on the basis of the restrictions corresponding to the combination of restrictions of the profiles of the members of the community.

### CROSS-REFERENCE TO RELATED APPLICATIONS

This application is a national phase entry under 35 U.S.C. §371 of International Patent Application PCT/FR2013/052401, filed Oct. 8, 2013, designating the United States of America and published in English as International Patent Publication WO 2014/057213 A1 on Apr. 17, 2014, which claims the benefit under Article 8 of the Patent Cooperation Treaty and under 35 U.S.C. §119(e) to France Patent Application Serial No. 1259723, filed Oct. 11, 2012, the disclosure of each of which is hereby incorporated herein in its entirety by this reference.

### TECHNICAL FIELD

The present invention relates to the field of interactive television, and more specifically the field of personalization of the access to contents and services accessible through a connected television set. Such television sets incorporate a decoder or are connected to an external decoder of the “set top box” type, which controls the access to a network and a service and multimedia content platform.

### BACKGROUND

Providing a profile manager making it possible to limit or to personalize the terms and conditions of access to the services and contents of the platform is known.

In particular, the European patent EP 1512257 discloses a terminal intended for receiving a broadband digital transmission, comprising a receiver and means for extracting metadata and a filter for processing such metadata with respect to specific preferences.

The patent application WO2011/163481 is also known, which describes a solution consisting of a multi-user remote control making it possible to manage several user profiles, with different access rights, e.g., a default profile for a family and profiles with differentiated rights for the father, the mother, a teenager and a child.

The patent EP1530115 describes another solution wherein the default profile is substantially the most restrictive profile.

The patent application WO2011/037761 provides a solution enabling a user to construct a merged profile by a deliberate action.

### BRIEF DESCRIPTION OF THE DRAWINGS

FIG. 1 is a simplified, schematic diagram illustrating communication between components of a system as described herein; and

FIG. 2 is a flow chart illustrating an embodiment of a method for personalizing interaction with multimedia content and services presented on a television set controlled by at least one peripheral device on the basis of a plurality of user profiles as described herein.

### DETAILED DESCRIPTION

The solutions of the prior art have a disadvantage in that they manage profiles generically, by a one-way linking of the activated profile and the interaction personalization mode associated with the active profile.

Therefore, during a family utilization, when access is activated by a user whose profile has few restrictions, family members whose profiles include more limited restrictions may have access to inappropriate content and services.

Moreover, the solutions of the prior art do not make it possible to use the television set before setting at least one profile, or define utilization without any limitation. In the solutions of the prior art, this default profile must be set manually. In case of error in or omission of certain restrictions, an individual user may be exposed to default access less restrictive than such individual rights.

Eventually, the solutions of the prior art provide a unique active profile, not allowing a user belonging to the community and having higher rights to access functionalities prohibited by the active profile.

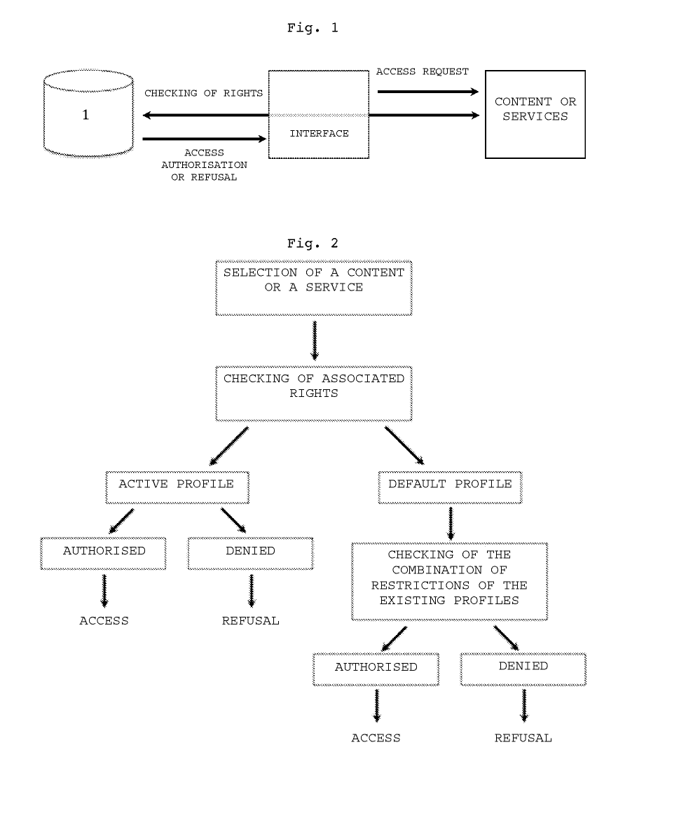

Referring to FIG. 1, in accordance with embodiments described herein, the decoder includes a memory wherein a table 1 is saved, which corresponds, for a default profile and N user profiles, to data defining the rights of access to available content and services.

The default profile is a profile without any restriction upon initialization. When creating or editing the user profiles, the default profile is edited so as to save, for each field and each service and content, a value corresponding to the most restrictive value among the existing profiles.

The table comprises, for each user, personal information such as a username, and optional personal data such as a photograph, a name, a personal code, etc.

The table also comprises fields for managing the access to the available services and content, and more particularly:
Use restriction fields such as “authorized/prohibited content,” authorized period, right of access to functions and services, more particularly pay services.
Personalization fields such as favorites, social networks connection parameters.

When a user selects some content or some service, such as a video-on-demand service, the decoder checks the status of the rights in the table, matching the service considered, according to the active profile.

Reading the table values corresponding to the active profile and the selected service defines the authorization or the refusal of access to the service, and if authorized, defines the functionalities available and the display thereof, performs the filtering of the viewable catalog and inhibits access to the other functionalities.

If the table defines, for the active profile, a refusal of access to the service, the decoder commands display information screen mentioning the absence of access rights.

If the table defines, for the active profile, a refusal of access to certain content, the decoder commands display not mentioning the not available contents and the unavailable categories, if any.

If no particular profile is activated, the decoder takes into account the default profile, which corresponds to the combination of the most limiting restrictions.

Creating a new profile is controlled from an administrator access, knowingly protected by a password of the “PIN” type.

It makes it possible to edit the table to create a new profile and to save the settings of the profile thus created. It also makes it possible to assign rights to change the profile settings to the associated user, if need be, using an identifier and possibly a personal password.

Some parameters are set by default, from predefined values for a category of users, for example, depending on the age group. The administrator may change the preset settings.

Each user may also save in the table information corresponding to social networks log-in parameters, which will be activated when selecting the considered profile, while enforcing the security scheme of the social network concerned.

As regards, the social networks with severe security terms and conditions, the access procedure provides a first authentication of the “username/password” type with the server of the social network, giving rise to an exchange of authentication tokens (“tokens”) that are saved in a field of the table or in a secure dedicated memory.

Upon subsequent access, the protocol of access to the social network is automated when selecting an associated profile, using the authentication token previously saved.

According to a preferred embodiment, the peripheral device controlling the decoder consists of equipment called in this patent a “companion” device such as a cell phone or a tablet.

In this case, the list of the profiles saved in the decoder table is transferred to the companion device at the time of matching the companion device and the decoder, so as to enable the selection of one of the profiles. Matching is associated with a specific profile.

It is also possible for the administrator to create and/or edit and/or delete the table profiles saved in the decoder, from the companion device.

The services and content displayed on the screen of the companion device and available from the companion device match the profile thereof and not the active profile in the decoder.

When the active profile in the decoder provides lower rights than those matching the profile of the person using the companion device, and when the user of the companion device wishes to share in the decoder some content or service unavailable to the active profile in the decoder, the decoder displays a request to enter an administrator code.

If several companion devices are simultaneously used, each user will be able to view and/or use on his/her companion device, the services and content matching his/her profile. The decoder will command, as in the case of the user of a single companion device, the display and use, on the television set, of the content and services matching the active profile in the decoder or the default profile.

To remedy the drawbacks of the prior art, the present invention, in its broadest sense, relates to a method for personalizing the interaction with multimedia content and services presented on a television set controlled by at least one peripheral device on the basis of a plurality of profiles, with the profiles defining at least one interaction personalization, characterized in that it comprises:
a step of forming a database containing a default profile corresponding to a user community, and at least one individual profile corresponding to a user who is a member of the community,
and steps of filtering access to the multimedia content and services and personalizing the interaction with the multimedia content and services on the basis of the selected user profile, and, if connected with the default profile, on the basis of the restrictions corresponding to the combination of restrictions of the profiles of the members of the community.

This solution makes it possible to define a collective default profile securely so determined as to prevent a user from having access, through the default profile, to higher rights than his/her individual rights.

It also gives access to the equipment without any personal profile and without any “companion” peripheral device including a saved personal profile.

In the case of the invention, at least the default profile is saved in the television set. Such default profile may optionally also be saved in the “companion” peripheral devices, in which case they are synchronized with the profile saved in the television set.

Individual profiles may be saved either in a “companion” peripheral device, conversing with the television set or in the television set proper, and in this case may be activated from a possibly shared peripheral device.

They each may also be saved in a personal peripheral device belonging to a member of the community, for example, his/her cell phone or his/her personal tablet. Such individual profiles are optionally copied into a memory in the television set.

The solution provided by the invention also makes it possible to continually adapt the rights associated with the default profile on the basis of changes brought to each one of the individual profiles of the community.

It also makes it possible to define a default profile suitable for use by the community of N users, by automatically configuring it not with respect to one of the N profiles, the rights of which are generally the most limited ones, but according to the most restrictive rights for each one of the available functionalities.

Thus, if in a family community:
a teenager has a right to purchase video on demand and to access a pay application platform, a right of access to his/her own social network account and is restricted as regards his/her access to some television channels,
a child of the same family has a right to purchase video on demand, a limited access to a pay application platform and a right of access to his/her own social network account and is restricted as regards his/her access to some television channels,
an adult has all the rights,
the default profile will include limitations to all the accesses to social networks, to the video on demand platform and to the application platform, as well as to the child's television channels.

The default profile is calculated dynamically. Thus, if a user's profile is the subject of a new restriction or removal of a restriction, it is not necessary to jointly edit the settings of the default profile. This avoids any inconsistency between the services available to a member of the community when he/she accesses the equipment through the default profile, and the services available to a member of the community when he/she accesses the equipment through his/her personal profile.

The user recovers his/her own rights as soon as he/she logs in with his/her personal profile.

A user may also access the equipment, even though he/she does not have a personal profile: the default profile saved in the television set will then be active.

In this patent “interaction with multimedia content and services” will mean:
The total or partial authorization or refusal of access to some content or service, for instance, according to certain time slots.
The limitation of the access to certain functionalities of some available content or service, for instance, the restriction of access to pay functions.
The setting of the access to a social network for a particular user.
The setting of the filtering functions of the available content, such as the level of parental control.
The setting of the favorite available content and services.
The monitoring of the user's preferences for recommending content and services.

The invention also relates to a decoder for a digital television, characterized in that it comprises a memory wherein a table is saved, which contains information for personalizing the interaction with multimedia content and services presented on a television set controlled by at least one peripheral device on the basis of a plurality of profiles, with the profiles defining at least one interaction personalization and so controlled as to implement:
a step of forming a database containing a default profile corresponding to a user community, and at least one individual profile corresponding to a user who is a member of the community,
and steps of filtering access to the multimedia content and services and of personalizing the interaction with the multimedia content and services on the basis of the selected user profile, and, if connected with the default profile, on the basis of the restrictions corresponding to the combination of restrictions of the profiles of the members of the community.

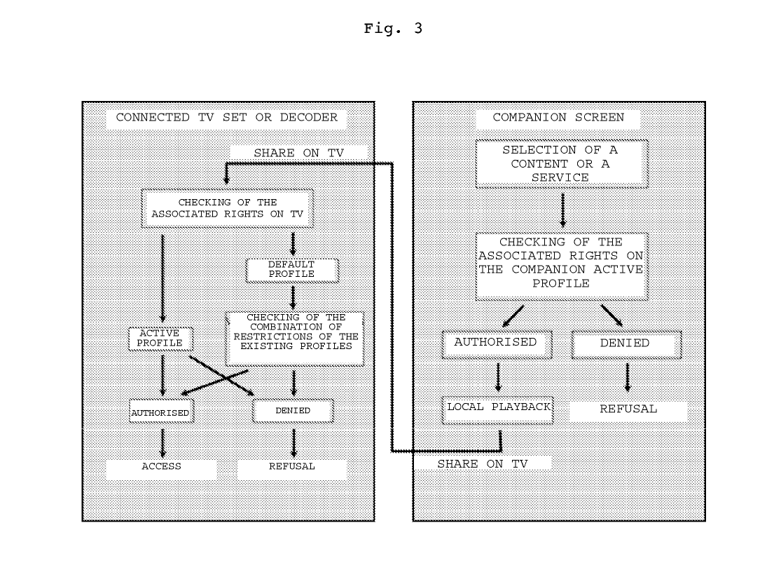

FIG. 2 is a flow chart illustrating an embodiment of a method for personalizing interaction with multimedia content and services presented on a television set controlled by at least one peripheral device on the basis of a plurality of user profiles as described herein

Advantageously, the decoder comprises means for interacting with a peripheral device, with the interacting means being capable of transmitting the list of the profiles saved in the table of the decoder to the companion device upon matching the companion device and the decoder, so as to enable the selection of one of the profiles. Matching is associated with a specific profile.

1-9. (canceled)

10. A method for personalizing interaction with multimedia content and services presented on a television set controlled by at least one peripheral device on the basis of a plurality of user profiles, with the user profiles defining at least one interaction personalization, comprising:
accessing a database in memory of at least one of the television set and the at least one peripheral device, the database containing a default profile corresponding to a user community, and at least one individual user profile corresponding to a user who is a member of the community;
filtering access to the multimedia content and services on the television set and personalizing the interaction with the multimedia content and services presented on the television set when connected with the default profile on a basis of restrictions corresponding to a combination of restrictions of profiles of the members of the community; and
displaying on at least the television set filtered access to the multimedia content and services and personalized interaction with the multimedia content and services.

11. The method of claim 10, further comprising dynamically changing a field of a table associated with the default profile stored in memory of a decoder associated with the television set including data defining the rights of access to available content and services for the default profile and N user profiles in response to a change in a corresponding field of the table associated with at least one of the user profiles.

12. The method of claim 11, wherein the table comprises access fields for managing access to the multimedia content and services, and further comprising populating the access fields with accessibility and personalization information including:
at least one use restriction field corresponding to one or more of “authorized/prohibited content,” authorized period, and right of access to functions and services; and
at least one personalization filed corresponding to one or more of favorites and social networks connection parameters.

13. The method of claim 11, further comprising populating the table with information corresponding to social network connection parameters activatable upon selecting the user profile, while enforcing a security scheme of the social network concerned.

14. The method of claim 10, further comprising defining the default profile to be free of restrictions upon initialization.

15. The method of claim 10, further comprising, when creating or editing the user profiles, editing the default profile to change, for each field of a plurality of fields corresponding to the multimedia content and services presented on the television set, a value to correspond to a most restrictive value among the user profiles.

16. The method of claim 10, further comprising populating the table with personal information corresponding to each user.

17. A decoder for a digital television set, comprising:
a video and audio output device;
an input receiver operatively connectable to at least one peripheral device;
at least one processor operatively connected to the video and audio output device and the input receiver; and
memory operatively connected to the at least one processor, the memory comprising a table stored in the memory, the table containing a default profile corresponding to a user community, and at least one individual user profile corresponding to a user who is a member of the community for personalizing user interaction with multimedia content and services presented on the digital television set in response to input at the input receiver from the at least one peripheral device on the basis of a plurality of user profiles, the user profiles defining at least one interaction personalization, the memory being programmed to:
filter access to the multimedia content and services on the television set and personalize the interaction with the multimedia content and services presented on the digital television set when connected with the default profile on the basis of the restrictions corresponding to the combination of restrictions of the profiles of the members of the community; and
send to at least the digital television set an electronic signal to cause the digital television set to display filtered access to the multimedia content and services and personalized interaction with the multimedia content and services.

18. A decoder for a digital television set, comprising a bi-directional communication module for interacting with a peripheral device, with the communication module configured for transmitting a list of profiles saved in a table stored in memory of the decoder to the companion device upon matching the companion device with the decoder, so as to enable the selection of one of the profiles, and wherein the matching is associated with a specific profile.
